(19) United States
(12) Patent Application Publication
(10) Pub. No.: US 2009/0172885 A1
(43) Pub. Date: Jul. 9, 2009

(54) Rapid deployment device

(76) Inventor: Carl Pete Giggleman, Cross Hill, SC (US)

Correspondence Address: BROOKE J. EGAN, 1114 BENTWOOD PLACE COURT, LOUISVILLE, KY, 40207, US

(21) Appl. No.: 12/006,871

(22) Filed: Jan. 7, 2008

(51) Int. Cl. A61G 1/00

(52) U.S. Cl. 5/625

(57) ABSTRACT

The present invention is a rapidly deployable device for the safe and efficient movement or evacuation of a non-ambulatory person who is positioned upon an underlying mat. The device comprises a support means and associated attachment means which partially or wholly encloses the underside of an underlying mat and attach a plurality of upper straps and an associated securing means which secures the non-ambulatory person to a top surface of the underlying mat. The device has at least one pull means which can be utilized to move the underlying mat by one individual by lifting or sliding.

### BACKGROUND OF THE INVENTION

Movement and evacuation of a non-ambulatory person becomes a crucial decision during an emergency situation. This decision is based in part the difficulty of the movement and evacuation pared with the physical condition and of the non-ambulatory person versus the scope of the emergency. During any movement or evacuation of a non-ambulatory person, extreme care must be used to insulate the person from further injury. Often when the decision for movement and evacuation has been made, timing has become crucial. Even moments of delay during a movement or evacuation, whether due to assembly, personnel error or otherwise, could make a difference in the safety and well being of the non-ambulatory person as well as the individual completing the rescue. There remains a need in the art for a device which is rapidly deployable for the safe and efficient movement or evacuation of a non-ambulatory person who is positioned upon an underlying mat, such as a mattress.

### SUMMARY OF THE INVENTION

The present invention relates generally to a device for moving or evacuating a non-ambulatory person positioned upon an underlying mat. More particularly, the present invention is a rapidly deployable device for the safe and efficient movement or evacuation of a non-ambulatory person who is positioned upon an underlying mat. The device comprises a support means and associated attachment means which partially or wholly enclose the underside of an underlying mat and attach a plurality of upper straps and an associated securing means which secures the non-ambulatory person to a top surface of the underlying mat. The device has at least one pull means which can be utilized to move the underlying mat by one individual by lifting or sliding.

In a preferred embodiment of the present invention, the securing means is a cover contoured into an adjustable bib which quickly deploys from the head of the underlying mat over the non-ambulatory person's head and torso and secures the non-ambulatory person to an underlying mat for movement or evacuation. In an alternate embodiment, the securing means are flaps which deploy from the sides of the underlying mat and are adapted to be adjustably lapped over to secure the non-ambulatory person's body to the underlying mat. As a further feature of the present invention and until deployment, the contoured cover of the preferred embodiment is stored in a compartment located at the head of the mat and the flaps of the alternate embodiment are stored in side compartments located on the side panels of the mat. In the preferred embodiment the device is incorporated into a pressure reducing mattress, as the underlying mat. In an alternate embodiment the device is a separate piece from the underlying mat and is positioned in relation to the mat prior to deployment. The device of the present invention includes a pull means for transportation during movement or evacuation. It is conceived herein that the present invention could include at least one pocket to securely hold medical or personal documents, medicines or objects, information chip or transmitter or a personnel locator, such as a global positioning or tracking device.

### DESCRIPTION OF THE DRAWINGS

FIG. 1 is a perspective view of the preferred embodiment of the present invention, with the securing means in a deployed position.

FIG. 2 is a perspective view of the preferred embodiment of FIG. 1, with the securing means in a contained with the associated storage compartment.

FIG. 3 is a perspective view of an alternate embodiment of the present invention, with the securing means in a deployed position.

### DETAILED DESCRIPTION OF THE INVENTION

It is a principle object of the present invention to provide a movement and evacuation device that is a rapidly deployable device for the safe and efficient movement or evacuation of a non-ambulatory person who is positioned upon an underlying mat. Additional objects and advantages of the invention are set forth in, or will be apparent to those of ordinary skill in the art from, the detailed description, figures and drawings and claims as follows. The accompanying figures and drawings, which are incorporated herein by reference and constitute a part of this specification, additionally illustrate an embodiment of the invention. Also, it should be further appreciated that modifications and variations to the specifically illustrated and discussed features and materials hereof may be practiced in various embodiments and uses of this invention without departing from the spirit and scope thereof, by virtue of present reference thereto. Still further, it is to be understood that different embodiments, as well as different presently preferred embodiments, of this invention, may include various combinations or configurations of presently disclosed features, elements, or their equivalents (including combinations of features or configurations thereof not expressly shown in the figures or stated in the detailed description). Such variations may include, but are not limited to, substitutions of the equivalent means, features, and materials for those shown or discussed, and the functional or positional reversal of various parts, features, or the like.

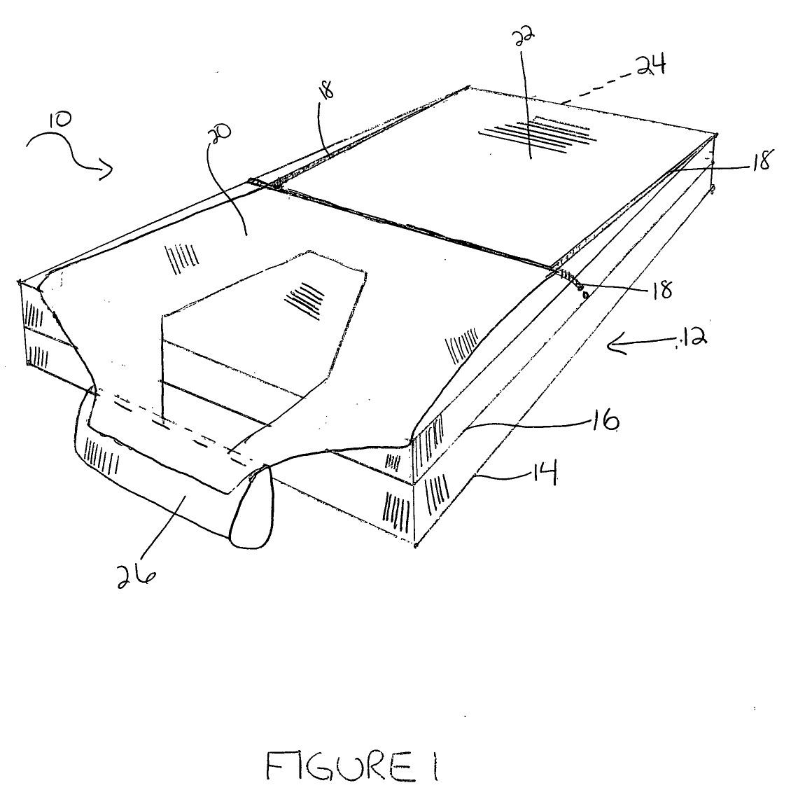

The present invention relates generally to a device for moving or evacuating a non-ambulatory person positioned upon an underlying mat. More particularly, the present invention is a rapidly deployable device for the safe and efficient movement or evacuation of a non-ambulatory person who is positioned upon an underlying mat. As shown in the embodiment of FIG. 1, the device (10) comprises a support means (14) and associated attachment means (16) which partially or wholly enclose the underside of an underlying mat (12) and attach a plurality of upper straps (18) and an associated securing means (20) which secures the non-ambulatory person to a top surface (22) of the underlying mat (12). The device (10) has at least one pull means (24) which can be utilized to move the underlying mat (12) by one individual by lifting or sliding.

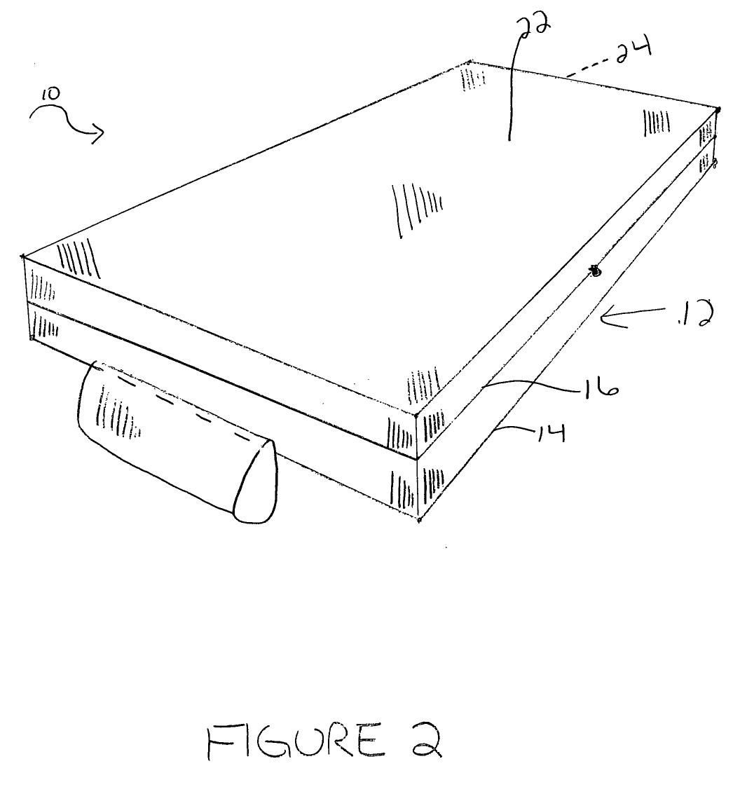

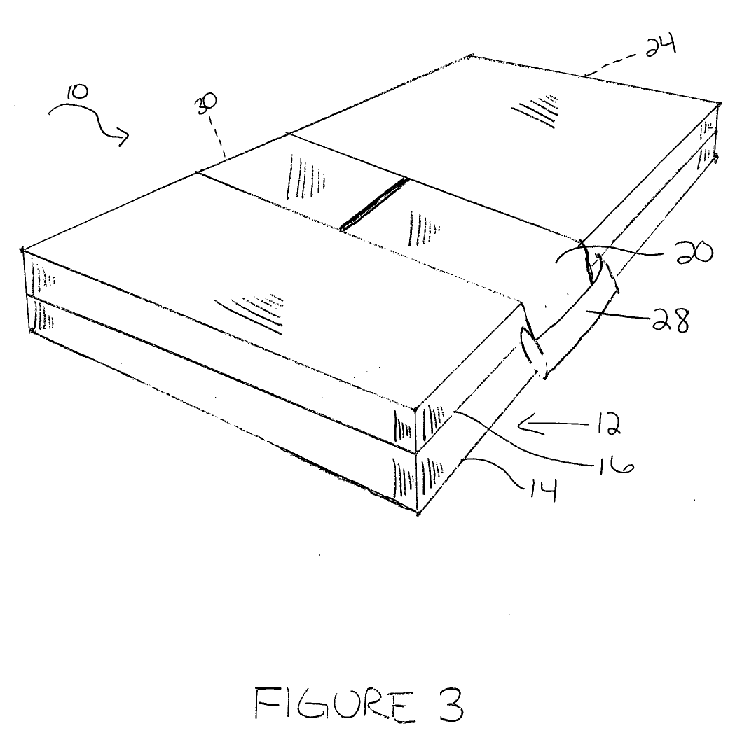

As shown in FIG. 1, in the preferred embodiment of the present invention the support means (14) is incorporated into the underlying mat (12) and provides support during moving or evacuation for the weight of the mat (12) and the non-ambulatory person. It is conceived and incorporated herein that the support means (14) can be comprised of a continuous or partial piece around the whole or part of the underlying mat (12), or any series or configuration of belts of any material or coating which provides the necessary support for movement or evacuation without departing from the spirit and scope of the present invention. In a preferred embodiment (10) of the present invention, the securing means (20) is a cover contoured into an adjustable bib which quickly deploys from the head of the underlying mat (12) over the non-ambulatory person's head and torso and secures the non-ambulatory person to an underlying mat (12) for movement or evacuation. The securing means (20) is preferably a fire-resistant, anti-microbial material, which can be cleaned in accordance with normal housekeeping practices, but such means (20) can be made of any material which would secure the non-ambulatory person without departing from the spirit and scope of the present invention. It is contemplated and disclosed herein that the securing means (20) could be in the form of a plurality of engaging belts which provide the same rapid and efficient positioning for the non-ambulatory person upon the underlying mat (12). In an alternate embodiment, as shown in FIG. 3, the securing means (20) are flaps which deploy from the sides of the underlying mat (12) and are adapted to be adjustably lapped together to secure the non-ambulatory person's body to the underlying mat (12). As a further feature of the present invention (10) and until deployment, the securing means (20) of the preferred embodiment is stored in a compartment (26) located at the head of the mat (12) and the securing means (20) of the alternate embodiment are stored in side compartments (28) located on the side panels of the mat (12). The compartment (26) of the preferred embodiment (10) has a zipper closure, but it is conceived and included that there are a variety of closures to be applied to the compartment of the present invention herein. Rapid deployment of the present invention is completed through the individual completing the rescue. FIG. 2 shows the securing means (20) contained within the compartment (26). For movement or evacuation utilizing the present invention (10), the individual completing the rescue would open the compartment (26) and pull the securing means (20) over the non-ambulatory person and then secure the plurality of straps (18) into alignment with the underlying mat (12), thereby securely positioning the non-ambulatory person to the underlying mat (12).

In the preferred embodiment as shown in FIG. 1, the device (10) is incorporated into a pressure reducing mattress, as the underlying mat (12). In an alternate embodiment the device (10) is a separate piece from the underlying mat (12) and is positioned in relation to the mat prior to deployment. The underlying mat (12) could be any supporting medium including, but not limited to a mattress, cushion, bed pillow, chair, pad or liner without departing from the spirit and scope of the present invention. In the preferred embodiment, the device (10) is approximately 34″ wide, while the underlying mat is 36″ wide, but the present invention encompasses all sizes of underlying mat.

In the preferred embodiment of the present invention shown in FIG. 1, the device (10) includes a pull means (24) which is secured to the underlying mat (12) for transportation. In an alternate embodiment, the pull means (24) may be secured to the securing means (20), attachment means (16), support means (14) or underlying mat (12). The pull means (24) may further comprise of any of a handle, loop or otherwise which allows for transportation of the underlying mat by pulling without departing from the spirit and scope of the present invention. It is conceived herein that the present invention include a pocket to securely hold medical or personal documents, medicines or objects, information chip or transmitter or a personnel locator, such as a global positioning or tracking device. The pocket could be secured to the underlying mat, the support means, the attachment means or the securing means without departing from the spirit and scope of the present invention.

Although a preferred and alternate embodiment of the invention has been described using specific terms and devices, such description is for illustrative purposes only. The words used are words of description rather than of limitation. It is to be understood that changes and variations may be made by those of ordinary skill in the art without departing from the spirit or the scope of the present invention. In addition, it should be understood that aspects of various other embodiments may be interchanged both in whole and in part. Therefore, the spirit and scope of the present invention should not be limited to the description of the preferred embodiment contained herein.

The embodiments of the present invention in which an exclusive property or privilege is claim are defined as follows:

1. A rapid deployment device for moving a non-ambulatory person, said deployment device comprising:
a. at least one support means secured to an underlying mat;
b. an attachment means attaching the support means to a plurality of upper straps which extend around the underlying mat; and
c. a securing means associated with the upper straps which secures the non-ambulatory person to a top surface of the underlying mat;
d. and at least one pull means for use in transport.

2. The rapid deployment device of claim 1, wherein said securing means is a contoured cover deployable over the non-ambulatory person with a plurality of belts engaging the support means, which securing means covers and securing said person to the underlying mat.

3. The rapid deployment device of claim 1, wherein said securing means are a plurality of belts engaging the support means, which securing means secures the non-ambulatory person to the top surface of the underlying mattress.

4. The rapid deployment device of claim 1 further comprising at least one pocket, which pocket is configured to securely hold documents and objects.

5. The rapid deployment device of claim 1, where said underlying mat is a mattress with a top surface generally for supporting the non-ambulatory person, a bottom surface substantially parallel to the top surface and four side surfaces positioned in relation to the top and bottom surfaces and substantially perpendicular to the top and bottom surfaces.

6. The rapid deployment device of claim 5, wherein said securing means a plurality of contoured flaps deployable over a portion of the non-ambulatory person's body, which flaps are adapted to be adjustably lapped together to secure the non-ambulatory person's body to the underlying mat.

7. The rapid deployment device of claim 6, wherein said flaps are stored in a plurality of storing means when not deployed, which storing means are adjacent to the mattress and secured to the attachment means.

8. The rapid deployment device of claim 5, wherein said securing means is a contoured cover deployable over the non-ambulatory person's head and torso with a plurality of belts engaging the support means, which securing means covers and securing said person to the underlying mat.

9. The rapid deployment device of claim 8, wherein said cover is stored in a storing means when not deployed, which storing means is adjacent to the top side surface of the mattress and secured to the attachment means.

10. The rapid deployment device of claim 5, wherein said securing means are a plurality of belts engaging the support means, which securing means secures the non-ambulatory person to the top surface of the underlying mattress.

11. The rapid deployment device of claim 5, wherein said support means is further comprised of a bottom sheet with a shaped form, which support means covers substantially whole of the bottom surface of the mattress and partially covers the four side surfaces of the mattress.

12. The rapid deployment device of claim 5, wherein said support means is further comprised of a plurality of interconnected belts adjacent to the bottom surface of the mattress.

13. The rapid deployment device of claim 5, wherein said support means is secured to the four side surfaces of the mattress.

14. The rapid deployment device of claim 5, wherein said pull means is stored in a second storing means when not deployed, which second storing means is adjacent to the bottom side surface of the mattress and secured to the support member.

15. A rapid deployment device for moving a non-ambulatory person positioned on an underlying mat comprising:
a. a support means positioned adjacent to a bottom surface of the underlying mat;
b. an attachment means attaching the support means to a contoured covering means which covers a portion of the non-ambulatory person's body;
c. a securing means associated with the covering means which secures the non-ambulatory person to the underlying mat;
d. and at least one pull means associated with the support means for use in transport.

16. The rapid deployment device of claim 15, wherein said support means is a sheet with a shaped form which covers substantially whole of the bottom surface of the mat.

17. The rapid deployment device of claim 15 further comprising at least one pocket, which pocket is configured to securely hold documents and objects.

18. The rapid deployment device of claim 15, wherein said cover means are a plurality of flaps adapted to be adjustably lapped together to secure the non-ambulatory person's body to the underlying mat.

19. A rapid deployment device for securing a non-ambulatory person to an underlying mattress, said harness system comprising:
a. a contoured covering means deployable over a portion of the non-ambulatory person's body for securing and covering said person to the top surface of the underlying mattress;
b. a support means connected to said covering means and integrated into the underlying mattress;
c. and at least one pull means integrated into the support means for use in transport.

20. The rapid deployment device of claim 19, wherein said support means further comprises a base means positioned adjacent to a bottom surface of the underlying mattress, an attachment means attaching the covering means to the base means at the head of the mattress and a strapping means which attaches the covering means to the base means at the foot of the mattress.
